(19) United States
(12) Patent Application Publication
(10) Pub. No.: US 2009/0115265 A1
(43) Pub. Date: May 7, 2009

(54) MOTOR FOR AN AERONAUTICAL FAN

(75) Inventor: Matthieu LEROY, Cadours (FR)

Correspondence Address: SUGHRUE MION, PLLC, 2100 PENNSYLVANIA AVENUE, N.W., SUITE 800, WASHINGTON, DC, 20037, US

(73) Assignee: TECHNOFAN, Blagnac (FR)

(21) Appl. No.: 12/265,402

(22) Filed: Nov. 5, 2008

(30) Foreign Application Priority Data
Nov. 7, 2007 (FR) 07 58851

(51) Int. Cl. H02K 37/20

(52) U.S. Cl. 310/46

(57) ABSTRACT

This motor of the type comprising a magnet-less rotor with studs, centred on an axis, and a stator which comprises a casing for conducting magnetic flux, at least two windings which are arranged on the casing and on the circumference of a circle which surrounds the rotor and which is centred on the axis, and at least two magnets, each being arranged on the circumference of the circle between two successive windings of the stator, wherein each magnet has in cross-section a width which increases progressively from the axis of the motor to the outer side of the motor.

### FIELD OF THE INVENTION

The present invention relates to a motor of the type comprising a magnet-less rotor with studs, centred on an axis, and a stator which comprises a casing for conducting magnetic flux, at least two windings which are arranged on the casing and on the circumference of a circle which surrounds the rotor and which is centred on the axis, and at least two magnets, each being arranged on the circumference of the circle between two successive windings of the stator.

The invention also relates to an aeronautical fan which comprises such a motor.

### BACKGROUND OF THE INVENTION

The ventilation systems of aircraft incorporate fans in order to ensure circulation of air in the ventilation pipes. These fans rotate at high speed and their motors must provide the best possible level of efficiency. A synchronous machine which has permanent magnets and which operates at high speed generates very significant losses at the rotor owing to induced current. A machine of variable reluctance is disadvantaged by a significant magnetising current. An architecture which is known and appropriate for the stresses of the high speed is a hybrid variable reluctance motor. The hybridisation involves the association of permanent magnets and a polyphased armature in the magnetic circuit of the stator.

The doctoral thesis “Etude et mise au point de motoventilateurs à hautes performances pour l'aéronautique” (Study and improvement of high-performance motor fans for aeronautics) by M. Matthieu LEROY, submitted on the 15 Nov. 2006, describes a motor comprising a magnet-less rotor with studs and a stator, comprising a casing for conducting magnetic flux, at least two windings which are arranged on the casing, and at least two magnets, each being arranged between two successive windings.

Each magnet is of rectangular parallelepipedal form. The dimensions of the magnets are defined by the space between two successive windings. The magnets are therefore of restricted size and do not allow the passage of the flux induced by the coils to be limited correctly.

The object of the invention is to provide a motor which allows better limitation of the passage of the flux induced by the coils between two poles of the stator.

### SUMMARY OF THE INVENTION

To this end, the invention relates to a motor of the above-mentioned type, wherein each magnet has in cross-section a width which increases progressively from the axis of the motor to the outer side of the motor.

According to other embodiments, the motor comprises at least one of the following features, taken in isolation or according to any technically possible combination:
the rotor comprises four protruding studs,
the rotor comprises stacked metal sheets,
the stator comprises precisely six windings,
the stator comprises only two magnets,
the magnets are diametrically opposed,
the casing has an outer circumference and each magnet has an outer edge, the outer edge of each magnet being flush with the outer circumference of the casing of the stator,
each magnet is in the form of a trapezium in cross-section,
the angle between the two sides of the trapezium which are separate from the large base and the small base is less than 360°/(2×Ns), where Ns represents the number of windings,
the relationship between the height of the trapezium and the minimum thickness of the casing over the circumference is between 1 and 2.2,
the length of each magnet in the direction of the axis of the motor is greater than or equal to the length of the casing in the direction of the axis of the motor, and
the motor is three-phase.

The invention also relates to an aeronautical fan, which comprises such a motor.

The invention and its advantages will be better understood from a reading of the following description, given purely by way of example and with reference to the appended drawings.

### BRIEF DESCRIPTION OF THE DRAWINGS

FIG. 1 is a longitudinal section of a fan which comprises a motor according to the invention, and

FIG. 2 is a cross-section of the motor according to the invention.

### DETAILED DESCRIPTION OF THE PREFERRED EMBODIMENT

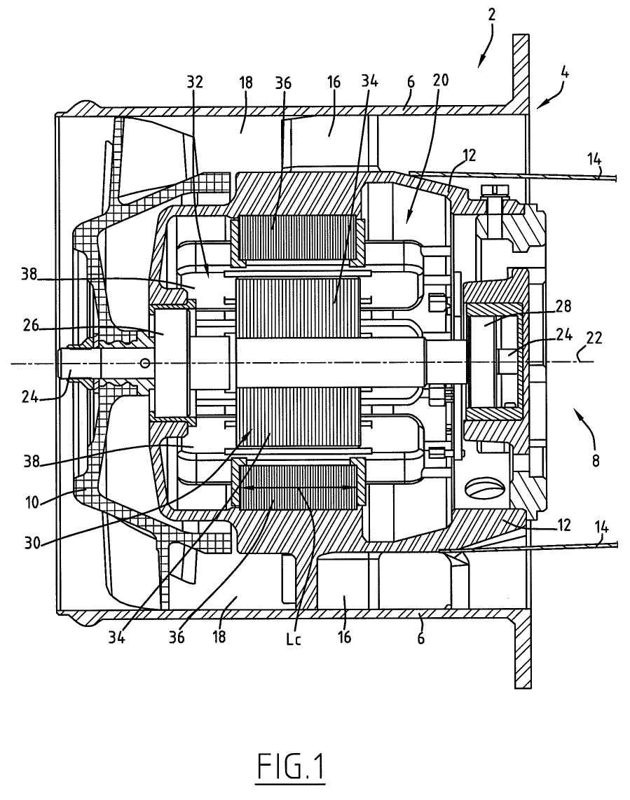

The fan 2 illustrated in FIG. 1 is intended to be placed in a ventilation system of an aircraft. It comprises, on the one hand, a support structure 4 comprising in particular a tubular outer conduit 6 and a bulb member 8 which is partially arranged inside the conduit 6 and, on the other hand, a wheel 10 which is mounted so as to be able to move in rotation about the bulb member 8.

The bulb member 8 has a frame 12 which carries a fairing 14. The frame 12 is provided with transverse arms 16 which connect it to the tubular conduit 6. The tubular conduit 6 is rigidly connected to the frame 12 in order to form the support structure 4. An annular channel 18 is delimited between the tubular conduit 6 and the bulb member 8.

An electric motor 20 is carried by the frame 12 and is accommodated inside the fairing 14. It is arranged along the axis 22 of the fan. The motor 20 has a shaft 24 which carries the wheel 10 at the end thereof. In the embodiment illustrated, the wheel 10 conforms to the shape of the bulb member 8. The wheel 10 is arranged at the side of the bulb member 8 via which the air is drawn in.

The shaft 24 of the motor 20 is carried by two ball bearings 26, 28. The bearings are arranged at one side and the other of the motor 20, a bearing 26 referred to as the front bearing being arranged between the motor 20 and the wheel 16, whilst the other bearing 28, referred to as the rear bearing, is arranged opposite the wheel 16 relative to the motor 20.

The rotor 30 of the motor is fixedly joined to the shaft 24 whilst the stator 32 of the motor is fixedly joined to the frame 12.

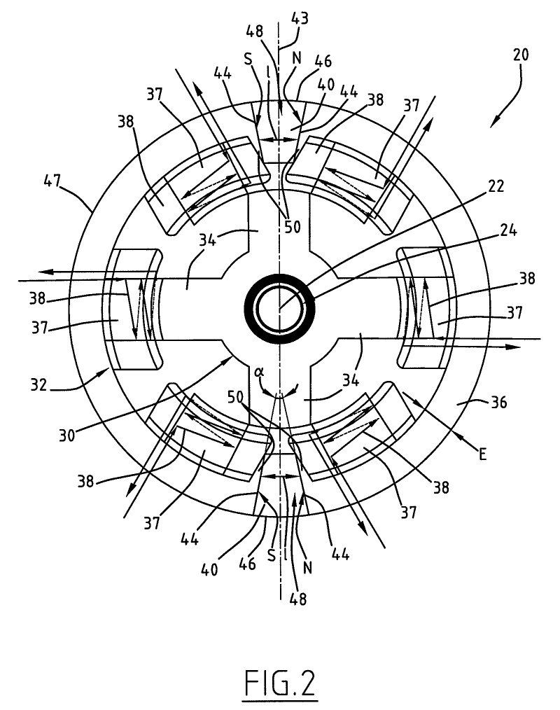

The rotor 30 is cross-shaped in cross-section and comprises four protruding studs 34 which can be seen in cross-section in FIG. 2. The four studs 34 are arranged radially from the axis 22 and are angularly distributed in a uniform manner. The rotor 30 comprises a stack of metal sheets, which can be seen in FIG. 1 and which are perpendicular relative to the axis 22. The metal sheets are, for example, ferromagnetic sheets. The rotor 30 does not comprise any magnet.

The stator 32 comprises a casing 36 for conducting magnetic flux, generally generated by means of revolution and surrounding the rotor 30. The casing 36 comprises six protruding studs 37, a winding 38 being wound around each stud 37. In the embodiment described, the number Ns of windings is therefore six. The stator 32 also comprises two magnets 40, each being arranged between two successive windings 38.

The protruding studs 37 are arranged radially relative to the axis 22 and are angularly distributed in a uniform manner. They are formed by protrusions which are directed towards the axis 22 of the motor.

The windings 38 are arranged on the circumference of a circle which surrounds the rotor 30 and which is centred on the axis 22. The turns of the windings 38 are orientated in the same direction.

The two magnets 40 are diametrically opposed relative to the axis 22. They are constituted by magnetic bars which are arranged longitudinally parallel with the axis 22. They separate the casing 36 into two independent half-cylinders.

The width 1 of the magnet 40 is measured in the direction of the tangent to a circle centred on the axis 22 at a point of the longitudinal centre plane 43 of the magnet 40, between the lateral faces 44 of the magnet. The centre plane 43 extends via the axis 22 and separates the magnet 40 into two equal portions. Each magnet 40 has in cross-section a width 1 which increases progressively from the axis 22 of the motor to the outer side of the motor 20.

The magnetic north pole N of the magnet is on a lateral face 44, the magnetic south pole S of the magnet being on the other lateral face 44. The two magnets 40 are orientated in the same direction relative to the centre plane 43. The north poles N of the two magnets are at the same side of the centre plane 43, the south poles S of the two magnets being at the other side of the centre plane 43.

Each magnet 40 is in the form of a trapezium in cross-section. The two sides of the trapezium which are separate from the large base and the small base together form an angle α which is less than 360°/(2×Ns). In the embodiment described, the angle α is substantially equal to 25°. The casing 36 has a minimum thickness E over the circumference thereof. The relationship between the height of the trapezium and the minimum thickness E is between 1 and 2.2. In the embodiment described, it is substantially equal to 1.8

The casing 36 has a length Lc which can be seen in FIG. 1 in the direction of the axis 22 of the motor 20. In the embodiment described, the length of each magnet 40 in the direction of the axis 22 is equal to the length Lc of the casing.

The outer edge 46 of the magnet is curved and is flush with the outer circumference 47 of the casing 36 of the stator. The large base of the magnet 40 is slightly curved in order to follow the outer shape of the stator 32.

Each magnet 40 is placed in a zone 48 between two windings 38. In each zone 48, the space between a lateral face 44 of the magnet and the corresponding face of a stud 37 is occupied by the casing 36 which has recessed edges 50.

In each zone 48, in the region of the axis of symmetry of the motor 20, the magnetic field is capable of varying by small amounts, compared with other zones of the motor 20.

The motor 20 is three-phase, each phase supplying two windings 38 which are diametrically opposed. The three phases of the motor 20 are magnetically decoupled.

The motor 20 is referred to as a dual-projection variable reluctance motor of the hybrid 6/4 type. The motor 20 is referred to as a variable reluctance motor owing to the fact that the symmetry pitch of the rotor 30 is different from that of the stator 32. The motor 20 is referred to as dual-projection owing to the fact that two protruding studs 37 of the stator are capable of simultaneously attracting two protruding studs 34 of the rotor. The motor 20 is referred to as the 6/4 type owing to the fact that it comprises six studs at the stator 32 and four studs at the rotor 30. The motor 20 is said to be hybrid owing to the fact that it also comprises permanent magnets 40 at the stator.

During operation, the phases of the motor 20 are independently supplied with bi-directional electrical currents. The power supply of the motor 20 is self-controlled, the currents having to be introduced relative to the position of the rotor 30.

The sign of the torque of the motor is positive when the protruding pins 34 of the rotor are close to the two windings 38 of the stator which are diametrically opposed and which are supplied with power by the corresponding phase, which corresponds to a period of growth of the flux. The sign of the torque of the motor is negative if the reverse is true.

In order to operate as a motor, a current of any sign must be successively introduced into the three phases during the growth periods of their flux until a position where the flux is at a maximum. The position of maximum flux corresponds to the alignment of the protruding studs 34 of the rotor with the studs 37 of the stator. In the maximum flux position, the rotor 30 is said to be in conjunction. In the minimum flux position, the rotor 30 is said to be in opposition.

The presence of the magnets 40 at the stator brings about an air gap and consequently a significant level of reluctance which creates a barrier to the propagation of the flux created by the winding 38. Part of the flux passes via another pair of studs 34. When magnets are present on the stator 32, the phase inductance is therefore weaker, when the rotor 30 is in conjunction or in opposition.

Magnets 40 according to the invention are larger than rectangular parallelepipedal magnets with the same spacing between two successive windings 38. In this manner, the magnets 40 bring about a more significant air gap and create a more effective barrier to the propagation of the flux created by the winding 38. The phase inductance is therefore weaker than with rectangular parallelepipedal magnets.

It should be noted that, in the absence of a phase, the motor continues to rotate in degraded mode, which contributes to the operating reliability of such a motor.

In a variant, the rotor 30 is constituted by a solid block of sintered material.

In a variant, the length of each magnet 40 in the direction of the axis 22 is greater than the length Lc of the casing.

What is claimed is:

1. Motor of the type comprising a magnet-less rotor with studs, centred on an axis, and a stator which comprises a casing for conducting magnetic flux, at least two windings which are arranged on the casing and on the circumference of a circle which surrounds the rotor and which is centred on the axis, and at least two magnets, each being arranged on the circumference of the circle between two successive windings of the stator, wherein each magnet has in cross-section a width which increases progressively from the axis of the motor to the outer side of the motor.

2. Motor according to claim 1, wherein the rotor comprises four protruding studs.

3. Motor according to claim 1, wherein the rotor comprises stacked metal sheets.

4. Motor according to claim 1, wherein the stator comprises precisely six windings.

5. Motor according to claim 2, wherein the stator comprises precisely six windings.

6. Motor according to claim 1, wherein the stator comprises only two magnets.

7. Motor according to claim 5, wherein the stator comprises only two magnets.

8. Motor according to claim 6, wherein the magnets are diametrically opposed.

9. Motor according to claim 1, wherein the casing has an outer circumference and each magnet has an outer edge, the outer edge of each magnet being flush with the outer circumference of the casing of the stator.

10. Motor according to claim 6, wherein the casing has an outer circumference and each magnet has an outer edge, the outer edge of each magnet being flush with the outer circumference of the casing of the stator.

11. Motor according to claim 1, wherein each magnet is in the form of a trapezium in cross-section.

12. Motor according to claim 6, wherein each magnet is in the form of a trapezium in cross-section.

13. Motor according to claim 11, wherein the angle between the two sides of the trapezium which are separate from the large base and the small base is less than 360°/(2×Ns), where Ns represents the number of windings.

14. Motor according to claim 12, wherein the angle between the two sides of the trapezium which are separate from the large base and the small base is less than 360°/(2×Ns), where Ns represents the number of windings.

15. Motor according to claim 11, wherein the relationship between the height of the trapezium and the minimum thickness of the casing over the circumference is between 1 and 2.2.

16. Motor according to claim 12, wherein the relationship between the height of the trapezium and the minimum thickness of the casing over the circumference is between 1 and 2.2.

17. Motor according to claim 1, wherein the length of each magnet in the direction of the axis of the motor is greater than or equal to the length of the casing in the direction of the axis of the motor.

18. Motor according to claim 14, wherein the length of each magnet in the direction of the axis of the motor is greater than or equal to the length of the casing in the direction of the axis of the motor.

19. Motor according to claim 16, wherein the length of each magnet in the direction of the axis of the motor is greater than or equal to the length of the casing in the direction of the axis of the motor.

20. Motor according to claim 1, wherein it is three-phase.

21. Aeronautical fan, which comprises a motor according to claim 1.
